(19) United States
(12) Patent Application Publication
(10) Pub. No.: US 2008/0126859 A1
(43) Pub. Date: May 29, 2008

(54) Methods and arrangements for distributed diagnosis in distributed systems using belief propagation

(76) Inventors: Shang Q. Guo, Ossining, NY (US); David M. Loewenstern, New York, NY (US); Natalia Odintsova, Elmsford, NY (US); Irina Rish, Rye Brook, NY (US)

Correspondence Address: FERENCE & ASSOCIATES LLC, 409 BROAD STREET, PITTSBURGH, PA, 15143, US

(21) Appl. No.: 11/514,706

(22) Filed: Aug. 31, 2006

(51) Int. Cl. G06F 11/28

(52) U.S. Cl. 714/25; 714/E11.178

(57) ABSTRACT

In the context of problems associated with self-healing in autonomic computer systems, and particularly, the problem of fast and efficient real-time diagnosis in large-scale distributed systems, a “divide-and-conquer” approach to diagnostic tasks is disclosed. Preferably, parallel (i.e., multi-thread) and distributed (i.e., multi-machine) architectures are used, whereby the diagnostic task is preferably divided into subtasks and distributed to multiple diagnostic engines that collaborate with each other in order to reach a final diagnosis. Each diagnostic engine is preferably responsible for some subset of system components (its “region”) and performs the diagnosis using all available observation about these components. When the regions do not intersect, the diagnostic task is trivially parallelized.

### FIELD OF THE INVENTION

The present invention relates to problems associated with self-healing in autonomic computer systems, and particularly, the problem of fast and efficient real-time diagnosis in large-scale distributed systems.

### BACKGROUND OF THE INVENTION

Herebelow, numerals presented in square brackets—[ ]—are keyed to the list of references found towards the close of the present disclosure.

In the context of the field of the invention just set forth, conventional techniques (e.g., the codebook approach of Kliger et al [1] and probabilistic inference with active probing approach of Rish et al [2]) typically employ a central event-correlation or inference engine that retains system information and analyzes incoming events. However, as the size of a system increases, both the frequency of events and the computational complexity of inference increase dramatically. A centralized single-engine diagnostic approach quickly becomes intractable and alternative approaches are needed. For example, there has previously been implemented a diagnostic system called RAIL (Real-time Active Inference and Learning) [2] that uses probabilistic real-time inference and relies on IBM's EPP (End-to-end Probing Platform) [3] tool for obtaining system's measurements called probes. Problems with RAIL have been noted in the context of larger systems, or for significantly large portions of an intranet. Accordingly, a need has been recognized in connection with effectively addressing such problems.

### SUMMARY OF THE INVENTION

Broadly contemplated herein, in accordance with at least one presently preferred embodiment of the present invention, is a “divide-and-conquer” approach to diagnostic tasks (such as those described heretofore) via using parallel (i.e., multi-thread) and distributed (i.e., multi-machine) architectures. As such, the diagnostic task is preferably divided into subtasks and distributed to multiple diagnostic engines that collaborate with each other in order to reach a final diagnosis.

Each diagnostic engine is preferably responsible for some subset of system components (its “region”) and performs the diagnosis using all available observation about these components. When the regions do not intersect, the diagnostic task is trivially parallelized. However, in general, different regions may have common components, and thus the conclusions made by one diagnostic engine may contain useful information for another engine; information exchange between the engines may improve their diagnostic accuracy. To address this issue, there is further proposed herein a distributed diagnostic approach based on probabilistic belief propagation (BP) [4] and its generalizations [5], which yields a naturally parallelizable message-passing algorithm for distributed probabilistic diagnosis, that eliminates computational bottleneck associated with a central monitoring server, and also improves the robustness of monitoring and diagnosis by avoiding single point of failure represented by a central monitoring server. Also proposed herein is a generic architecture that supports BP and allows communication between diagnostic engines that run in parallel either on same or different machines (depending on the scale of diagnosis).

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates a conventional simple network.

FIG. 2 schematically illustrates a sample network which includes diagnostic nodes.

FIG. 3 schematically conveys a Bayesian representation of the network of FIG. 2.

FIG. 4 schematically illustrates an example of iterative belief propagation.

FIG. 5 schematically illustrates a network which includes intersecting probes.

FIG. 6 schematically illustrates a system architecture.

### DESCRIPTION OF THE PREFERRED EMBODIMENTS

Although a general approach is broadly contemplated herein, which can be applied to a very wide variety of prospective environments, the disclosure now turns to a specific example of example of a “probing” approach to problem diagnosis [2,3]. A “probe”, as may be broadly understood for the discussion herein, is an end-to-end transaction (e.g., ping, webpage access, database query, an e-commerce transaction, etc.) sent through the system for the purposes of monitoring and testing. Usually, probes are sent from one or more probing stations (designated machines), and ‘go through’ multiple system components, including both hardware (e.g. routers and servers) and software components (e.g. databases and various applications).

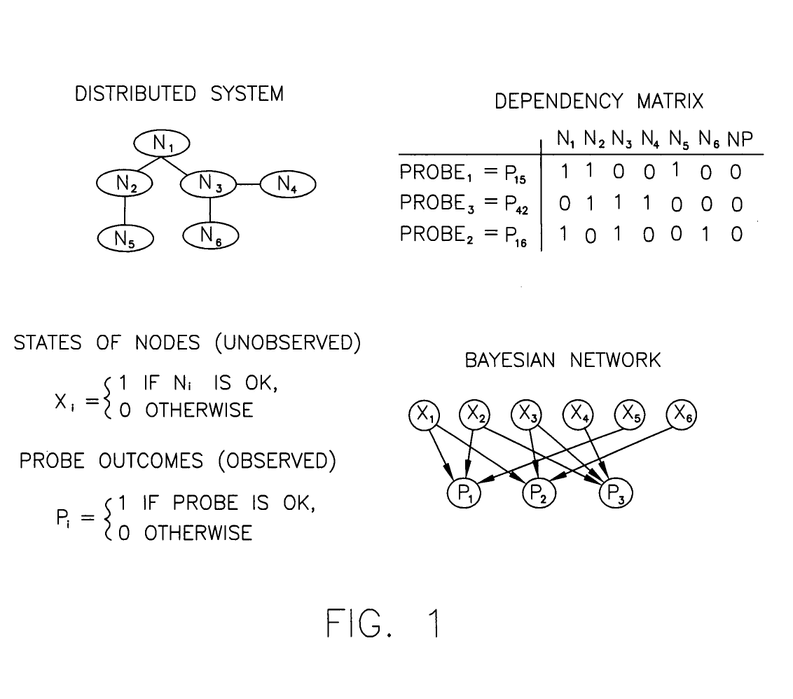

Formally, one may consider a set X={X₁, . . . , Xₙ} of system components, a set T={T₁, . . . , Tₘ} of tests (probes), and an m n×dependency matrix [dᵢⱼ] where the columns correspond to the components, the rows correspond to the probes, and dᵢⱼ=1 if executing probe i involves component j, and 0 otherwise. For example, FIG. 1 shows a simple network with 2 probe stations at nodes 1 and 6, and a dependency matrix including 3 probes.

In the presence of noise, different prior fault probabilities, and multiple failures, one may preferably apply a probabilistic approach to diagnosis that can use a convenient framework of Bayesian networks. The dependency matrix can be mapped to a two-layer Bayesian network [4] where the states of components Xᵢ correspond to upper-level variables and the probes Tᵢ correspond to the lower-layer variables, whose parents are the components influencing the probe's outcome and specified by 1 in corresponding row of the dependency matrix. For example, FIG. 1 shows such a Bayesian network corresponding to the dependency matrix above. In this example, it is assumed that components Xᵢ are marginally independent, and each probe outcome depends only on the components tested by this probe. These assumptions yield a joint distribution

P(X,T)=Πᵢ₌₁ⁿP(X₁)Πⱼ₌₁^{m}P(Tⱼ|pa(Tⱼ))

where P(Xᵢ) is a prior distribution of Xᵢ.

Given the probe outcomes, diagnosis consists in finding most-likely combination of faults that “explain” the observed probe outcomes. Unfortunately, solving this problem exactly can be computationally expensive or even impossible as the exact inference is known to be an NP-hard problem. Thus, in accordance with at least one presently preferred embodiment of the present invention, a “belief propagation” algorithm is preferably employed as a tool of approximation. Preferably, this tool is can also easily be parallelized and thus be implemented in distributed fashion (especially desirable if one prefers to off-load a central management server).

Belief propagation (BP), in essence, may be thought of as a simple linear-time message-passing algorithm that is provably correct on polytrees (i.e., Bayesian networks with no undirected cycles) and that can be used as an approximation on general networks. Preferably, belief propagation passes probabilistic messages between the nodes and can be iterated until convergence (guaranteed only for polytrees); otherwise, it can be stopped at a given number of iterations. The algorithm computes approximate beliefs P(Xᵢ|T) for each node.

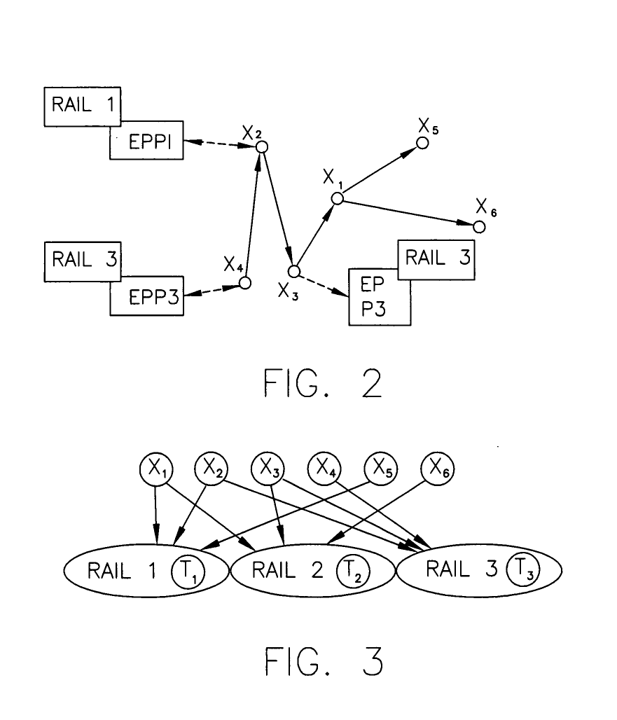

By way of a simple (and non-restrictive) example, one may consider a network where several nodes are designated diagnostic nodes (called RAIL—real-time active inference and learning engine nodes), with associated EPP (end-to-end probing software); this is schematically illustrated in FIG. 2. In this example there are three RAIL nodes each with associated EPP, in addition to six “standard” nodes X₁ . . . X₆. In turn, the problem illustrated in FIG. 2 can be represented a Bayesian network as shown in FIG. 3.

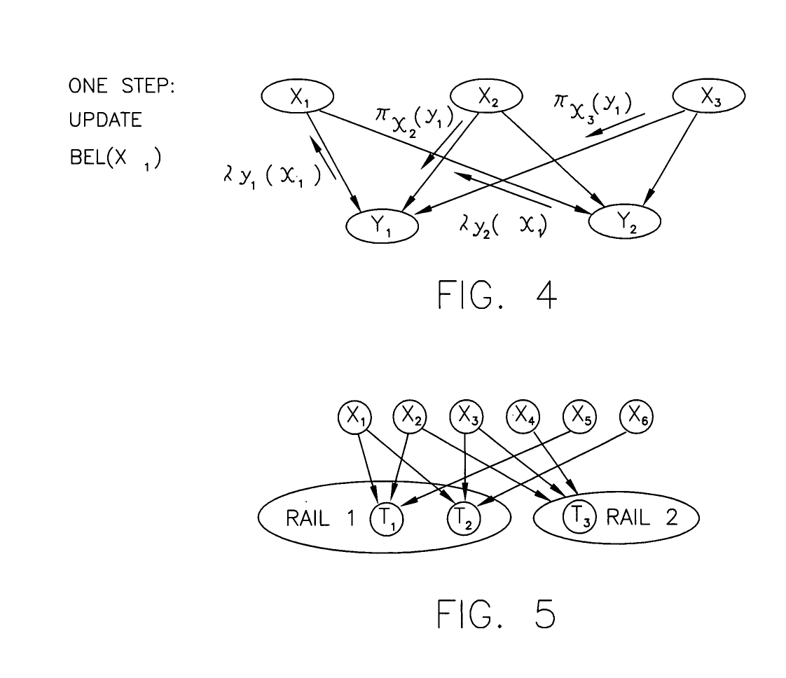

Preferably, iterative belief propagation works by sending messages between nodes and updating probabilities (also called beliefs) at every node, as shown in FIG. 4. Assuming that there are several diagnostic engines (e.g., multiple RAIL systems) controlling different subsets of components then, desirably, the subsets will be made independent so that the inference problem would trivially decompose. However, in practice, this may not always be possible. For example, in considering the probing approach, let it be assumed that each diagnostic engine is making inferences based on its own subset of probes, as shown in FIG. 5.

Here RAIL1 receives probes T₁ and T₂ and therefore diagnoses nodes {X₁, X₂, X₃, X₅, X₆}, while RAIL2 received probe T₃ and diagnoses nodes {X₂, X₃, X₄}. Thus, the subsets of nodes intersect due to probe intersection (which is quite common, especially when a probe set needs to be optimized so that a minimal number of probes covers the system) and therefore beliefs obtained by different diagnostic engines about these nodes must be combined. Such combination can be brought about naturally by applying belief propagation in a distributed way, so that each RAIL will be responsible for keeping and updating messages related to its nodes. Clearly all factor nodes in the corresponding factor graph that involve a RAIL's nodes will belong to that RAIL as well.

Preferably, a system architecture (generally, a hierarchical one) will be employed that is a publish-subscribe architecture for message exchange between different diagnostic/monitoring nodes (peers, also called RAILs above) through higher-level “councilors”, using “message patterns” that describe which messages and where should be sent by each RAIL, and which messages it expects to receive from its peers.

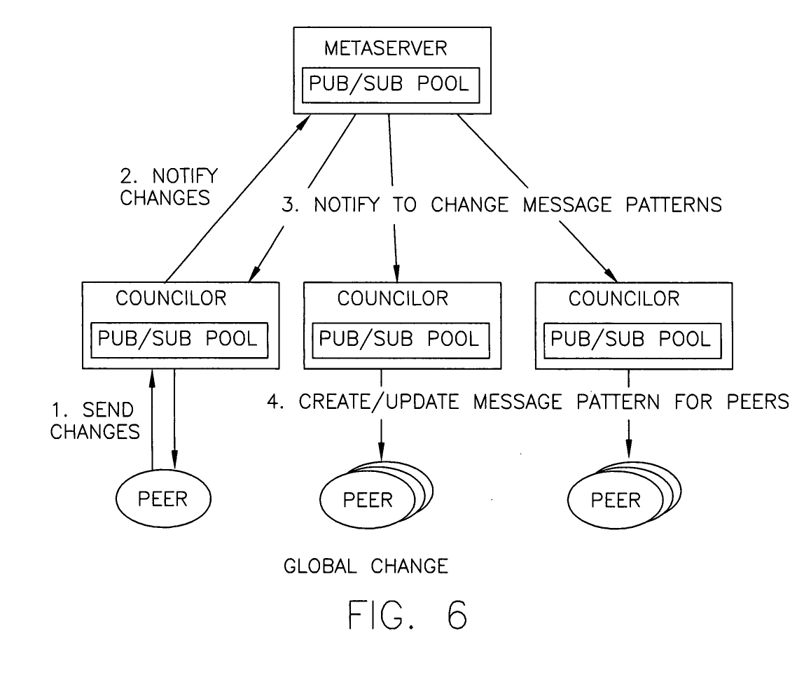

Preferably, the system topology (as shown in FIG. 6) includes three tiers of nodes wherein: the bottom tier contains the peer nodes which are actually diagnosis engines and iteratively calculate and update the beliefs of system states for covered components; the middle tier contains the super-peer nodes, also called councilors, which are centralized servers to their subsets of peers and hold a publication/subscription (abbreviated as pub/sub) pool (one per councilor) for the purpose of sharing information among local peers; and the top tier contains a metaserver node playing the role of bootstrapping node, providing monitor services, keeping an index directory for all councilors and a pub/sub pool for sharing information globally. In a real system, a node can be both councilor and peer or both councilor and metaserver depending on the size of network.

Preferably, dynamic message patterns are also supported in order to handle changes in the system, such as leaving and joining nodes both in the system under control and in our diagnostic infrastructure (e.g., addition of new RAIL engines, or unexpected failure of such an engine).

It is to be understood that the present invention, in accordance with at least one presently preferred embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### REFERENCES

[1] S. Kliger, S. Yemini, Y. Yemini, D. Ohsie, and S. Stolfo. A coding approach to event correlation. In Intelligent Network Management (IM), 1997.
[2] I. Rish, M. Brodie, N. Odintsova, S. Ma, G. Grabarnik, Real-time Problem Determination in Distributed Systems using Active Probing, in Proceedings of NOMS-2004, Seoul, Korea, April 2004.
[3] A. Frenkiel and H. Lee. EPP: A Framework for Measuring the End-to-End Performance of Distributed Applications. In Proc. Performance Engineering Best Practices Conference, IBM Academy of Technology, 1999.
[4] J. Pearl, Probabilistic Reasoning in Intelligent Systems, Morgan Kaufmann, 1988.
[5] J. S. Yedidia, W. T. Freeman, and Y. Weiss, Constructing free energy approximations and generalized belief propagation algorithms, Technical Report TR-2004-040, MERL, May 2004.
[6] M. Welsh, D. Culler, and E. Brewer, SEDA: An Architecture for Well-Conditioned Scalable Internet Service, in Proceedings of the 18th ACM Symposium on Operating Systems Principles, October 2001.
[7] I. Clarke, O. Sandberg, B. Wiley, and T. W. Hong. Freenet: A Distributed Anonymous Information Storage and Retrieval System. In Designing Privacy Enhancing Technologies: International Workshop on Design Issues in Anonymity and Unobservability. Springer, New York, 2001
[8] B. Yang, H. Garcia-Molina, Designing a Super-Peer Network, Proceedings of ICDE, 2003.
[9] Napster: http://www.napster.com/
[10] Gnutella: http://www.gnutella.com/
[11] I. Stoica, R. Morris, D. Karger, F. Kaashoek, and H. Balakrishnan, Chord: A scalable peer-to-peer lookup service for Internet applications, Proceedings of ACM SIGCOMM'2001, August 2001
[12] P. Druschel and A. Rowstron. Pastry: Scalable, distributed object location and routing for large-scale peer-to-peer systems, Proceedings of the 18 IFIP/ACM International Conference on Distributed Systems Platforms (Middleware 2001), Heidelberg, Germany, November 2001
[13] B. Zhao, J. Kubiatowicz, and A. Joseph, Tapestry: An Infrastructure for Fault-tolerant Wide-area Location and Routing, U. C. Berkeley Technical Report UCB//CSD-01-1141, April 2000.

What is claimed is:

1. A method for affording collaborative problem determination in a distributed system, said method comprising the steps of:
appending at least one measurement component to a distributed system;
employing the at least one measurement component to obtain system status information;
sharing system status information among system nodes; and
diagnosing a problem in the distributed system based on shared system status information.

2. The method according to claim 1, further comprising the step of adding or deleting a system component reponsive to a system change.

3. The method according to claim 1, further comprising the step of adding or deleting at least one measurement component and/or at least one diagnostic component responsive to a system change.

4. The method according to claim 1, further comprising the step of subdividing at least one system component and/or at least one measurement component into regions, responsive to an increase in at least one of: a number of system components and a number of measurement components.

5. The method according to claim 4, wherein said subdividing step comprises subdividing at least one system component and/or at least one measurement component into intersecting regions.

6. The method according to claim 1, wherein said step of employing the at least one measurement component to obtain system status information comprises obtaining system status information via local inference.

7. The method according to claim 1, wherein said step of sharing system status information comprises employing belief propagation.

8. The method according to claim 1, wherein said step of employing the at least one measurement component to obtain system status information comprises employing the at least one measurement component to probe the system via at least one end-to-end transaction.

9. The method according to claim 1, further comprising the step of reporting diagnostic results locally.

10. The method according to claim 1, further comprising the step of reporting diagnostic results globally.

11. A apparatus for affording collaborative problem determination in a distributed system, said apparatus comprising:
an arrangement for appending at least one measurement component to a distributed system;
an arrangement for employing the at least one measurement component to obtain system status information;
an arrangement for sharing system status information among system nodes; and
an arrangement for diagnosing a problem in the distributed system based on shared system status information.

12. The apparatus according to claim 11, further comprising an arrangement for adding or deleting a system component reponsive to a system change.

13. The apparatus according to claim 11, further comprising an arrangement for adding or deleting at least one measurement component and/or at least one diagnostic component responsive to a system change.

14. The apparatus according to claim 11, further comprising an arrangement for subdividing at least one system component and/or at least one measurement component into regions, responsive to an increase in at least one of: a number of system components and a number of measurement components.

15. The apparatus according to claim 14, wherein said subdividing arrangement acts to subdivide at least one system component and/or at least one measurement component into intersecting regions.

16. The apparatus according to claim 11, wherein said arrangement for employing the at least one measurement component to obtain system status information acts to obtain system status information via local inference.

17. The apparatus according to claim 11, wherein said arrangement for sharing system status information acts to employ belief propagation.

18. The apparatus according to claim 11, wherein said arrangement for employing the at least one measurement component to obtain system status information acts to employ the at least one measurement component to probe the system via at least one end-to-end transaction.

19. The apparatus according to claim 11, further comprising an arrangement for reporting diagnostic results locally and/or globally.

20. A program storage device readable by machine, tangibly embodying a program of instructions executable by the machine to perform method steps for affording collaborative problem determination in a distributed system, said method comprising the steps of:
appending at least one measurement component to a distributed system;
employing the at least one measurement component to obtain system status information;
sharing system status information among system nodes; and
diagnosing a problem in the distributed system based on shared system status information.
